(19) United States
(12) Patent Application Publication
(10) Pub. No.: US 2023/0079543 A1
(43) Pub. Date: Mar. 16, 2023

(54) ELECTROMAGNETIC DEVICE DESIGN SYSTEM FOR FAST FREQUENCY SWEEP BASED ON FINITE ELEMENT METHOD

(71) Applicant: Tianjin University, Tianjin (CN)

(72) Inventors: Feng FENG, Tianjin (CN); Jianan ZHANG, Tianjin (CN); Qijun ZHANG, Tianjin (CN); Wei ZHANG, Tianjin (CN); Jing JIN, Tianjin (CN); Wei LIU, Tianjin (CN)

(21) Appl. No.: 17/898,468

(22) Filed: Aug. 29, 2022

(30) Foreign Application Priority Data
Aug. 27, 2021 (CN) 202110992300.2

(51) Int. Cl. G06F 30/23

(52) U.S. Cl. CPC G06F 30/23

(57) ABSTRACT

The disclosure provides an electromagnetic device design system including: one or more processors of a machine; and computer-storage medium storing instructions, which when executed by the machine, cause the machine to perform operations for EM sensitivity analysis for an electromagnetic (EM) device. The operations include: initiating physical parameters of the EM device, wherein the EM device comprises multiple ports; performing EM simulation for the EM device at a pre-solution frequency using the finite-element method (FEM); applying single-size matrix Padé via Lanczos (MPVL) method in fast frequency sweep and performing EM simulation for the EM device under excitation at each port to obtain field solution of the EM device at frequencies in a frequency range; calculating S-parameters for the multiple ports of the EM device; and calculating derivatives of the S-parameters with respect to one of the physical parameters in the frequency range.

### CROSS-REFERENCE TO RELAYED APPLICATIONS

Pursuant to 35 U.S.C.§ 119 and the Paris Convention Treaty, this application claims foreign priority to Chinese Patent Application No. 202110992300.2 filed Aug. 27, 2021, the contents of which, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to the technical field of electromagnetic device design. In particular, the disclosure addresses systems and methods for performing an electromagnetic sensitivity analysis by using fast frequency sweep based on the finite element method.

Electromagnetic sensitivity analysis is important for electromagnetic (EM) device design. An EM sensitivity is defined as a derivative of an EM response, e.g., a full scattering matrix for ports of an EM device, with respect to a physical parameter of the EM device including geometrical parameters and material parameters. EM device design, such as design optimization, what if analysis and yield-driven design, benefits greatly from the EM sensitivity analysis.

As one of the most efficient numerical techniques, the finite-element method (FEM) is used to perform the EM device design routinely. However, using FEM to solve a large linear system is very time-consuming. Especially when the equations are frequency dependent, the solution process for a single frequency must be repeated once at each different frequency.

Recent efforts have focused on Model order reduction (MORe) techniques, such as the asymptotic waveform evaluation (AWE), the Galerkin AWE (GAWE), the well-conditioned AWE (WCAWE), the projection via Arnoldi, the Padé via Lanczos (PVL), the matrix Padé via Lanczos (MPVL), and the adaptive Lanczos-Pade sweep (ALPS). Using MORe techniques, the EM equation is merely solved at a single value of a parameter and solutions at other values of the parameter are estimated approximately with a small computational overhead, thus speeding up the whole simulating process.

However, model order reduction techniques cannot be directly used in the EM sensitivity analysis.

### SUMMARY

The disclosure provides a system for performing an electromagnetic sensitivity analysis by using fast frequency sweep based on finite element method (FEM). Adjoint/self-adjoint formulas based on fast frequency sweep are derived, predicting the EM sensitivity information for the entire frequency range, and thus the efficiency of the EM sensitivity analysis is improved.

Conventional commercial software typically computes electromagnetic response derivatives at multiple frequencies and are less efficient. The disclosure incorporates a model order reduction algorithm and aims to speed up the electromagnetic sensitivity analysis. Increasing the number of frequencies to be solved results in a reduction in the execution time of the disclosure (for example, the disclosure gets a 30 times speedup when calculating the electromagnetic response derivatives at 100 frequencies).

Specifically, in one aspect, the disclosure provides an electromagnetic device design system comprising:

one or more processors of a machine; and

computer-storage medium storing instructions, which when executed by the machine, cause the machine to perform operations for EM sensitivity analysis for an electromagnetic (EM) device, the operations comprising:

initiating physical parameters of the EM device, wherein the EM device comprises multiple ports;

performing EM simulation for the EM device at a pre-solution frequency using the finite-element method (FEM);

applying single-size matrix Padé via Lanczos (MPVL) method in fast frequency sweep and performing EM simulation for the EM device under excitation at each port to obtain field solutions of the EM device in a frequency range;

calculating S-parameters for the multiple ports of the EM device;

obtaining derivatives of a full scattering matrix for the multiple ports with respect to the physical parameters of the EM device in the frequency range;

selecting a solution and updating EM device design to replace initial values of the physical parameters of the EM device with a selected solution;

performing EM simulation for the EM device at a frequency of the selected solution using FEM; and

determining the simulated result satisfies a physical specification of the EM device;

wherein:

applying single-size MPVL method in fast frequency sweep comprises:

transforming a single-size system matrix with a dimension of N×N into a double-size system matrix with a dimension of 2N×2N for omitting second order terms of frequency, wherein N represents a number of elements in a field vector and the single-size system matrix is of a linear combination of global finite-element system matrices;

generating a first linear system using the double-size system matrix;

representing solving vectors of the first linear system with the global finite-element system matrices using the block matrix inversion method and transforming the first linear system into a second linear system, wherein the second linear system is of the single-size system matrix; and

solving the second linear system by performing fast frequency sweep incorporated with MPVL method and obtaining field solution in a frequency range as the following:

xₖ≈xₖ^{q}=∥r₀∥Vₖ^{q}(I_{q}−(s−s₀)Tₖ^{q})⁻¹e₁

where

s represents a frequency;

s₀ represents a pre-solution frequency;

q is a reduced order in MPVL method;

xₖ is a vector of field solution under excitation at port k;

xₖ^{q}, represents a vector of qₜₕ order reduced field solution under excitation at port k;

r₀ represents a solution vector of the first linear system at 0^{th} MPVL iteration;

Vₖ^{q} is represented as Vₖ^{q}=[vₘ]ₘ₊₁^{q}=[v₁ v₂ . . . v_{q}], where vₘ is an orthonormal basis vector of the Krylov subspace for model order reduction;

I_{q} is an identity matrix with a dimension of q×q;

Tₖ^{q} is a reduced order matrix; and

e₁ is represented as e₁=[1 0 . . . 0]^{T} with a dimension of 1×q.

In a second aspect, an electromagnetic device design system comprises:

one or more processors of a machine; and

computer-storage medium storing instructions, which when executed by the machine, cause the machine to perform operations for EM sensitivity analysis for an electromagnetic (EM) device, the operations comprising:

initiating physical parameters of the EM device wherein the EM device comprises multiple ports;

performing EM simulation for the EM device at a pre-solution frequency using the finite-element method (FEM);

solving a linear system under excitation at port j to obtain a field solution under excitation at port j by fast frequency sweep;

solving an adjoint representation of the linear system under excitation at port k to obtain an adjoint field solution between port k and port j by fast frequency sweep;

calculating derivatives of a S-parameter of port j and port k with respect to Oᵢ based on an adjoint sensitivity formula;

obtaining derivatives of a full scattering matrix for the multiple ports with respect to the physical parameters of the EM device in the frequency range;

selecting a solution and updating EM device design to replace the one of the physical parameters of the EM device with the selected solution;

performing EM simulation for the EM device at a frequency of the selected solution using FEM; and

determining the simulated result satisfies a physical specification of the EM device;

wherein the adjoint sensitivity formula is written as

$$\frac{\partial {S}_{k , j}}{\partial {ϕ}_{i}} = - {\hat{x}}_{k , j}^{T} ( {\tilde{G}}_{i} + s {\tilde{C}}_{i} ) {x}_{j} ,$$

where

xⱼ represents a vector of the field solution under excitation at port j;

\tilde{G}ᵢ represents a derivative of G with respect to ϕᵢ;

\tilde{C}ᵢ represents a derivative of C with respect to ϕᵢ;

s is a frequency;

\hat{x}_{k,j}^{T} represents a transpose vector of the adjoint field solution between port j and port k;

S_{k,j} represents the S-parameter of port j and port k; and

ϕᵢ represents an iₜₕ one of the physical parameters.

In a third aspect, an electromagnetic device design system comprises:

one or more processors of a machine; and

computer-storage medium storing instructions, which when executed by the machine, cause the machine to perform operations for EM sensitivity analysis for an electromagnetic (EM) device, the operations comprising:

initiating physical parameters of the EM device wherein the EM device comprises multiple ports;

performing EM simulation for the EM device at a pre-solution frequency using the finite-element method (FEM);

solving a linear system under excitation at port j to obtain a field solution under excitation at port j by fast frequency sweep;

solving the linear system under excitation at port k to obtain a field solution under excitation at port k by fast frequency sweep;

calculating derivatives of a S-parameter of port j and port k with respect to ϕᵢ based on a self-adjoint sensitivity formula;

obtaining derivatives of a full scattering matrix for the multiple ports with respect to the physical parameters of the EM device in the frequency range;

selecting a solution and updating EM device design to replace initial values of the physical parameters of the EM device with the selected solution;

performing EM simulation for the EM device at a frequency of the selected solution using FEM; and

determining the simulated result satisfies a physical specification of the EM device;

wherein

the self-adjoint sensitivity formula is written as

$$\frac{\partial {S}_{k , j}}{\partial {ϕ}_{i}} = - {κ}_{k , j} {x}_{k}^{T} ( {\tilde{G}}_{i} + s {\tilde{C}}_{i} ) {x}_{j} ,$$

where

xⱼ represents a vector of the field solution under excitation at port j;

\tilde{G}ᵢ represents a derivative of G with respect to ϕᵢ;

\tilde{C}ᵢ represents a derivative of C with respect to ϕᵢ;

s is a frequency;

xₖ^{T} represents a transpose vector of the field solution under excitation at port k;

S_{k,j} represents the S-parameter of port j and port k;

ϕᵢ represents an iₜₕ one of the physical parameters; and

κ_{k,j} represents a correlated coefficient of port j and port k.

In a fourth aspect, an electromagnetic device design system comprises:

one or more processors of a machine; and

computer-storage medium storing instructions, which when executed by the machine, cause the machine to perform operations for EM sensitivity analysis for an electromagnetic (EM) device, the operations comprising:

initiating physical parameters of the EM device wherein the EM device comprises multiple ports;

performing EM simulation for the EM device at a pre-solution frequency using the finite-element method (FEM);

solving a linear system under excitation at port j by performing fast frequency sweep with single-size MPVL method to obtain an order reduced field solution under excitation at port j in a frequency range;

solving an adjoint representation of the linear system under excitation at port k by performing fast frequency sweep with single-size MPVL method to obtain an order reduced adjoint field solution between port k and port j in the frequency range;

calculating derivatives of a S-parameter of port j and port k with respect to Oᵢ based on an adjoint sensitivity formula;

obtaining derivatives of a full scattering matrix for the multiple ports with respect to the physical parameters of the EM device in the frequency range;

selecting a solution and updating EM device design to replace initial values of the physical parameters of the EM device with the selected solution;

performing EM simulation for the EM device at a frequency of the selected solution using FEM; and

determining the simulated result satisfies a physical specification of the EM device;

wherein:

performing fast frequency sweep with single-size MPVL method comprises:

transforming a single-size system matrix with a dimension of N×N into a double-size system matrix with a dimension of 2N×2N for omitting second order terms of frequency, wherein N represents the number of elements in a field vector and the single-size system matrix comprises a linear combination of global finite-element system matrices;

generating a first linear system using the double-size system matrix;

representing solving vectors of the first linear system with the global finite-element system matrices using block matrix inversion method and transforming the first linear system into a second linear system, wherein the second linear system is of the single-size system matrix; and

solving the second linear system by performing fast frequency sweep incorporated with MPVL method and obtaining a field solution in a frequency range by the following:

xₖ≈xₖ^{q}=∥r₀∥Vₖ^{q}(I_{q}−(s−s₀)Tₖ^{q})⁻¹e₁;

and the adjoint sensitivity formula is written as:

$$\frac{\partial {S}_{k , j}}{\partial {ϕ}_{i}} \approx - {\hat{x}}_{k , j}^{Tq} ( {\tilde{G}}_{i} + s {\tilde{C}}_{i} ) {x}_{j}^{q} ,$$

where

s represents a frequency;

s₀ represents a pre-solution frequency;

q is a reduced order in MPVL method;

xₖ is a vector of field solution under excitation at port k;

xₖ^{q}, represents a vector of qₜₕ order reduced field solution under excitation at port k;

r₀ represents a solution vector of the first linear system at 0^{th} MPVL iteration;

Vₖ^{q} is represented as Vₖ^{q}=[vₘ]ₘ₌₁^{q}=[v₁ v₂ . . . v_{q}], where vₘ is an orthonormal basis vector of the Krylov subspace for model order reduction;

I_{q} is an identity matrix with a dimension of q×q;

Tₖ^{q} is a reduced order matrix;

e₁ is represented as e₁=[1 0 . . . 0]^{T} with a dimension of 1×q;

\tilde{G}ᵢ represents a derivative of G with respect to ϕᵢ;

\tilde{C}ᵢ represents a derivative of C with respect to ϕᵢ;

\hat{x}_{k,j}^{qT} represents a transpose vector of qth order reduced adjoint field solution between port j and port k;

S_{k,j} represents the S-parameter of port j and port k; and

ϕᵢ represents an iₜₕ one of the physical parameters.

In a fifth aspect, an electromagnetic device design system comprises:

one or more processors of a machine; and

computer-storage medium storing instructions, which when executed by the machine, cause the machine to perform operations for EM sensitivity analysis for an electromagnetic (EM) device, the operations comprising:

initiating physical parameters of the EM device wherein the EM device comprises multiple ports;

performing EM simulation for the EM device at a pre-solution frequency using the finite-element method (FEM);

performing fast frequency sweep with single-size MPVL method to obtain an order reduced field solution under excitation at port j of the EM device in a frequency range;

performing fast frequency sweep with single-size MPVL method to obtain an order reduced field solution under excitation at port k of the EM device in a frequency range;

calculating derivatives of a S-parameter of port j and port k with respect to ϕᵢ based on a self-adjoint sensitivity formula;

obtaining derivatives of a full scattering matrix for the multiple ports with respect to the physical parameters of the EM device in the frequency range;

selecting a solution and updating EM device design to replace initial values of the physical parameters of the EM device with the selected solution;

performing EM simulation for the EM device at a frequency of the selected solution using FEM; and

determining the simulated result satisfies a physical specification of the EM device;

wherein:

performing fast frequency sweep with single-size MPVL method comprises:

transforming a single-size system matrix with a dimension of N×N into a double-size system matrix with a dimension of 2N×2N for omitting second order terms of frequency, wherein N represents the number of elements in a field vector and the single-size system matrix comprises a linear combination of global finite-element system matrices;

generating a first linear system using the double-size system matrix;

representing solving vectors of the first linear system with the global finite-element system matrices using block matrix inversion method and transforming the first linear system into a second linear system, wherein the second linear system is of the single-size system matrix; and

solving the second linear system by performing fast frequency sweep incorporated with MPVL method and obtaining field solution of the EM device in a frequency range as the following:

xₖ≈xₖ^{q}=∥r₀∥Vₖ^{q}(I_{q}−(s−s₀)Tₖ^{q})⁻¹e₁,

and the self-adjoint sensitivity formula is written as

$$\frac{\partial {S}_{k , j}}{\partial {ϕ}_{i}} \approx - {κ}_{k} {x}_{k}^{qT} ( {\tilde{G}}_{i} + s {\tilde{C}}_{i} ) {x}_{j}^{q} ,$$

where

s represents a frequency;

s₀ represents a pre-solution frequency;

q is a reduced order in MPVL method;

xₖ is a vector of the field solution under excitation at port k;

xₖ^{q} represents qₜₕ order reduced solution vector under excitation at port k;

r₀ represents a solution vector of the first linear system at 0^{th} MPVL iteration;

Vₖ^{q} is represented as Vₖ^{q}=[vₘ]ₘ₌₁^{q}=[v₁ v₂ . . . v_{q}], where vₘ is an orthonormal basis vector of the Krylov subspace for model order reduction;

I_{q} is an identity matrix with a dimension of q×q;

Tₖ^{q} is a reduced order matrix;

e₁ is represented as e₁=[1 0 . . . 0]^{T} Or with a dimension of 1×q;

xⱼ^{q} represents qₜₕ order reduced solution vector under excitation at port j;

\tilde{G}ᵢ represents a derivative of G with respect to ϕᵢ;

\tilde{C}ᵢ represents a derivative of C with respect to ϕᵢ;

xₖ^{qT} represents a transpose vector of qth order reduced field solution under excitation at port k;

S_{k,j} represents the S-parameter of port j and port k;

ϕᵢ represents an iₜₕ one of the physical parameters; and

κ_{k,j} represents a correlated coefficient of port j and port k.

The following advantages are associated with the electromagnetic sensitivity analysis method of the disclosure:

The proposed single-size MPVL method transforms an EM linear system to be solved into a one of single-size matrices. And the adjoint/self-adjoint EM sensitivity analysis for fast frequency sweep are generated to calculate derivative of S-parameter of the multiple ports of the EM device, allowing for direct application of MPVL method for model order reduction calculation in EM sensitivity analysis. When fast frequency sweep using single-size MPVL method is performed for EM sensitivity analysis, repetitive solving process due to different frequencies is avoided and computational cost of the EM device design system is saved, leading to a sufficiently enhanced simulation efficiency.

### BRIEF DESCRIPTION OF THE DRAWINGS

FIG. 1 is a flow chart for the operations performed by the invented device design system in the embodiment of this microwave filter.

FIG. 2 is a perspective view of a four-pole waveguide filter according to one embodiment of the disclosure;

FIG. 3 is another perspective view of a four-pole waveguide filter according to one embodiment of the disclosure;

FIG. 4 is graph depicting Derivatives of ReS₁₁ and ImS₁₁ with respect to h₁ at ϕ₁ for the four-pole waveguide filter with the frequency swept from 10.5 GHz-11.5 GHz;

FIG. 5 is graph depicting Derivatives of ReS₂₁ and ImS₂₁ with respect to h₁ at ϕ₁ for the four-pole waveguide filter with the frequency swept from 10.5 GHz-11.5 GHz;

FIG. 6 is graph depicting Derivatives of ReS₁₁ and ImS₁₁ with respect to h_{c1} at ϕ₁ for the four-pole waveguide filter with the frequency swept from 10.5 GHz-11.5 GHz; and

FIG. 7 is graph depicting Derivatives of ReS₂₁ and ImS₂₁ with respect to h_{c2} at ϕ₁ for the four-pole waveguide filter with the frequency swept from 10.5 GHz-11.5 GHz.

### DETAILED DESCRIPTION

For an EM device design system, an adjoint formula and a self-adjoint formula that are respectively integrated with fast frequency sweeps are generated to improve EM sensitivity analysis for EM device designs. Further, a single-size MPVL method is proposed for model order reduction and is used in fast frequency sweep for the present EM sensitivity analysis. The present EM sensitivity analysis method obtains the same accuracy as the techniques of the prior art, while taking much less time by avoiding repetitively solving large systems of EM equations for different frequencies.

The single-size MPVL method incorporated in fast frequency sweep is derived as follows:

the Helmholtz equation for the full wave EM simulation is formulated as:

$$∇ \times ( \frac{1}{μ} ∇ \times E ) - {ω}^{2} ϵ E = - j ω J , \qquad ( 1 )$$

where ∈ and μ represent the permittivity and the permeability of the medium, respectively; ω represents the angular frequency; J represents the electric current source of the EM problem; E represents the electric field intensity to be solved; finite element method (FEM) is one of the commonly used methods to solve this Helmholtz equation; assuming that the EM simulation is performed on an EM device comprising multiple ports; the FEM equation in a general form is written as:

(K₀+sK₁+s²K₂)x=sbⱼ, (2)

where s represents the complex frequency corresponding to ω; x represents the unknown field solution vector containing the unknown values of E for FEM; K₀, K₁, and K₂ represent global finite-element system matrices, which are dependent on the physical parameters of the EM device but independent on frequency; bⱼ represents a vector describing the excitation at the port j; to obtain the full scattering matrix of the multi-port structure, the S-parameters can be written as

$$\begin{matrix}{S}_{k , j} ( s ) = {κ}_{k , j} {b}_{k}^{T} x - {δ}_{k , j} \\ = s {κ}_{k , j} {{b}_{k}^{T} ( {K}_{0} + {sK}_{1} + {s}^{2} {K}_{2} )}^{- 1} {b}_{j} - {δ}_{k , j} ,\end{matrix} \qquad ( 3 )$$

$$where$$

$${δ}_{k , j} = \{ \begin{matrix}1 , & k = j \\ 0 , & k \neq j\end{matrix} , \qquad ( 4 )$$

κ_{k,j} is a correlated coefficient of port j and port k, which is constant for a constant EM device and is dependent on the powers incident upon the port k and port j of the EM device.

To use MPVL method on FEM system, the order of frequency terms contained in the EM equations would be no more than a first order. Therefore, Equation (3) is reformatted as:

$${S}_{k , j} ( s ) = {{\hat{β}}_{k , j}^{T} ( G + sC )}^{- 1} {β}_{j} , \qquad ( 5 )$$

$$where$$

$${\hat{β}}_{k , j} = [ \begin{matrix}s {κ}_{k , j} {b}_{k} \\ {0}_{N \times 1}\end{matrix} ] , \\ G = [ \begin{matrix}{0}_{N} & {I}_{N} \\ {K}_{0} & {K}_{1}\end{matrix} ] , \\ C = [ \begin{matrix}- {I}_{N} & {0}_{N} \\ {0}_{N} & {K}_{2}\end{matrix} ] , \\ {β}_{j} = [ \begin{matrix}{0}_{N \times 1} \\ {b}_{j}\end{matrix} ] . \qquad ( 6 )$$

where I_{N} and 0_{N} represent the identity matrix and zero matrix in [symbol] ^{N×N}, respectively. Here, N is the number of elements in x. Let ϕ represent a vector of the physical parameters of the EM device, where ϕᵢ (i=1, . . . , p) represent the iₜₕ element in ϕ, and p is the total number of physical parameters.

To use MPVL method to perform the fast frequency sweep, one specific frequency is selected and defined as the pre-solution frequency; with the suitable selection of the pre-solution frequency, the accurate EM solutions can be obtained over the entire frequency band by solving the large linear system once at the pre-solution frequency; let s₀ represent the pre-solution frequency for MPVL method; let Kₛ represent a single-size system matrix at the pre-solution frequency, which has a dimension of N×N and is written as

Kₛ=K₀+s₀K₁+s₀²K₂, (7)

let Aₛ represent a double-size system matrix having a dimension of 2N×2N and is defined as

$${A}_{s} = G + {s}_{0} C = [ \begin{matrix}- {s}_{0} {I}_{N} & {I}_{N} \\ {K}_{0} & {K}_{1} + {s}_{0} {K}_{2}\end{matrix} ] . \qquad ( 8 )$$

where Aₛ is calculated at the pre-solution frequency s₀; let q be the order of the reduced model using MPVL; let Tₖ^{q} be defined as the reduced order matrix with the elements t_{l,m}, i.e.,

$${T}_{k}^{q} = {[ {t}_{l , m} ]}_{q \times q} ,$$

where l=1, 2, . . . , q and m=1, 2, . . . , q; let {wₘ}ₘ₌₁^{q} be defined as a set of unit vectors which are orthonormal to each other; let V: be defined as the matrix containing the orthonormal basis of the Krylov subspaces for the model order reduction, where Vₖ^{q}=[vₘ]ₘ₌₁^{q}=[v₁ v₂ . . . v_{q}]; let rₘ be defined as the vector for the calculation of Vₖ^{q} and Tₖ^{q} in the mₜₕ MPVL iteration; rₘ is calculated by solving a first linear system as:

$${A}_{s} {r}_{m} = \{ \begin{matrix}{β}_{k} , & m = 0 , \\ - {Cv}_{m} , & m = 1 , 2 , … , q .\end{matrix} \qquad ( 9 )$$

using MPVL as the model order reduction technique to perform the fast frequency sweep; calculating the LU factors of the matrix Aₛ;

because the size of Aₛ is twice the size of Kₛ, the computational cost for the LU factorization of Aₛ takes much longer time than that of Ks;

therefore, a single-size MPVL method is derived to perform the LU factorization of the single-size system matrix Kₛ, instead of the double-size system matrix Aₛ; using the block matrix inversion method, Equation (9) is reformulated as:

$$\begin{matrix}{r}_{0} = \frac{1}{{s}_{0}} [ \begin{matrix}{K}_{s}^{- 1} {K}_{0} - I & {s}_{0} {K}_{s}^{- 1} \\ {s}_{0} {K}_{s}^{- 1} {K}_{0} & {s}_{0}^{2} {K}_{s}^{- 1}\end{matrix} ] [ \begin{matrix}{0}_{N \times 1} \\ {b}_{k}\end{matrix} ] \\ = [ \begin{matrix}{I}_{N} \\ {s}_{0} {I}_{N}\end{matrix} ] {K}_{s}^{- 1} {b}_{k} ,\end{matrix} \qquad ( 10 )$$

$$and$$

$$\begin{matrix}{r}_{m} = \frac{1}{{s}_{0}} [ \begin{matrix}{K}_{s}^{- 1} {K}_{0} - I & {s}_{0} {K}_{s}^{- 1} \\ {s}_{0} {K}_{s}^{- 1} {K}_{0} & {s}_{0}^{2} {K}_{s}^{- 1}\end{matrix} ] [ \begin{matrix}{I}_{N} & {0}_{N} \\ {0}_{N} & - {K}_{2}\end{matrix} ] {v}_{m} \\ = \frac{1}{{s}_{0}} [ \begin{matrix}{I}_{N} \\ {s}_{0} {I}_{N}\end{matrix} ] {{K}_{s}^{- 1} [ \begin{matrix}{K}_{0} \\ - {s}_{0} {K}_{2}\end{matrix} ]}^{T} {v}_{m} \\ - \frac{1}{{s}_{0}} [ \begin{matrix}{I}_{N} & {0}_{N} \\ {0}_{N} & {0}_{N}\end{matrix} ] {v}_{m ,}\end{matrix} \qquad ( 11 )$$

let uₘ be defined as the solution vector for a second linear system as

$${K}_{s} {u}_{m} = \{ \begin{matrix}{b}_{k} , & m = 0 \\ {\frac{1}{{s}_{0}} [ \begin{matrix}{K}_{0} \\ - {s}_{0} {K}_{2}\end{matrix} ]}^{T} {v}_{m} , & m = 1 , 2 , … , q .\end{matrix} \qquad ( 12 )$$

substituting (12) into (10) and (11),

$${r}_{0} = [ \begin{matrix}{u}_{0} \\ {s}_{0} {u}_{0}\end{matrix} ] , \qquad ( 13 )$$

$$and$$

$${r}_{m} = [ \begin{matrix}{u}_{m} \\ {s}_{0} {u}_{m}\end{matrix} ] - \frac{1}{{s}_{0}} [ \begin{matrix}{I}_{N} & {0}_{N} \\ {0}_{N} & {0}_{N}\end{matrix} ] {v}_{m} , \qquad ( 14 )$$

where m represents the MPVL iteration index, i.e., m=1, 2, . . . , q; let xₖ^{q} represent the qₜₕ order reduced vector (q×1 vector), the solution vector xₖ under excitation at port k of the device can be formulated as,

xₖ≈xₖ^{q}=∥r₀∥Vₖ^{q}(I_{q}−(s−s₀)Tₖ^{q})⁻¹e₁, (15)

where e₁[1 0 . . . 0]^{T}∈ [symbol] ^{q}, is the unit vector in [symbol] ^{q}; I_{q} is an identity matrix in [symbol] ^{q×q}.

according to Equation (3), the S-parameters can be obtained by substituting the solution vector xₖ with the Equation (15) and be formulated as

S_{k,j}(S)=∥r₀∥\hat{β}_{k,j}^{T}Vₖ^{q}(I_{q}−(s−s₀)Tₖ^{q})⁻¹e₁−δ_{k,j}, (16)

where, S-parameters corresponding to a frequency range can be evaluated by performing fast frequency sweep integrated with the single-size MPVL method.

The following is derivation of the adjoint EM sensitivity analysis using fast frequency sweep model order reduction technique.

Letting \tilde{G}ᵢ and \tilde{C}ᵢ represent the derivatives of G and C with respect to a physical parameter of the device ϕᵢ, respectively. \tilde{G}ᵢ and \tilde{C}ᵢ can then be derived as,

$${\tilde{G}}_{i} = [ \begin{matrix}{0}_{N} & {0}_{N} \\ {\tilde{K}}_{0}^{i} & {\tilde{K}}_{1}^{i}\end{matrix} ] , \\ {\tilde{C}}_{i} = [ \begin{matrix}{0}_{N} & {0}_{N} \\ {0}_{N} & {\tilde{K}}_{2}^{i}\end{matrix} ] . \qquad ( 17 )$$

where \tilde{K}₀ⁱ, \tilde{K}₁ⁱ, and \tilde{K}₂ⁱ represent the sensitivity of K₀, K₁, and K₂ with respect to the physical parameter ϕᵢ, respectively; to calculate the sensitivity of S_{i, j}, the sensitivities of the global finite-element system matrices w.r.t. physical parameters \tilde{K}₀ⁱ, \tilde{K}₁ⁱ, and \tilde{K}₂ⁱ need to be firstly obtained;

obtaining the vector bⱼ from the EM excitation and/or the boundary conditions on the jₜₕ port; the structures of the ports normally do not change during the EM design; thus bⱼ is a constant vector w.r.t. to a physical parameter ϕᵢ in the EM problem, i.e.,

$$\frac{\partial {b}_{j}}{\partial {ϕ}_{i}} = {0}_{N \times 1} . \qquad ( 18 )$$

based on (5), formulating the derivatives of S_{k,j} as,

$$\frac{\partial {S}_{k , j}}{\partial {ϕ}_{i}} = - {{\hat{β}}_{k , j}^{T} ( G + sC )}^{- 1} ( {\tilde{G}}_{i} + s {\tilde{C}}_{i} ) {( G + sC )}^{- 1} {β}_{j} . \qquad ( 19 )$$

letting xⱼ represent the solution vector for a linear system that is written as

(G+sC)xⱼ=βⱼ. (20)

calculating the solution vector xⱼ in (20) by MORe techniques such as MPVL method;

defining \hat{x}_{k,j} as a vector of adjoint field solution of the adjoint representation of the linear system (20), the adjoint representation is written as follows,

(G+sC)^{T}\hat{x}_{k,j}=\hat{β}_{k,j}. (21)

the adjoint solution vector \hat{x}_{k,j} in (21) is calculated similarly to xⱼ by MORe techniques such as MPVL method;

substituting (20) and (21) into (19) to obtain the adjoint sensitivity formula of S_{k,j} w.r.t. ϕᵢ as,

$$\frac{\partial {S}_{k , j}}{\partial {ϕ}_{i}} = {\hat{x}}_{k , j}^{T} ( {\tilde{G}}_{i} + s {\tilde{C}}_{i} ) {x}_{j} , \qquad ( 22 )$$

Equation (22) is the adjoint sensitivity formula which is well fit for fast frequency sweep. MORe technique can be used to calculate xⱼ and \hat{x}_{k,j}; since the format of (22) is derived using MPVL, xⱼ and \hat{x}_{k,j} can be formulated using MPVL method,

$$\frac{\partial {S}_{k , j}}{\partial {ϕ}_{i}} \approx - {\hat{x}}_{k , j}^{q T} ( {\tilde{G}}_{i} + s {\tilde{C}}_{i} ) {x}_{j}^{q} . \qquad ( 23 )$$

The following is derivation of the self-adjoint EM sensitivity analysis using fast frequency sweep model order reduction technique.

The disclosure further provides a self-adjoint EM sensitivity analysis. Because G and C are formulated as 2×2 block matrices, by substituting (6) into (20) and using the 2×2 block matrix inversion method, we can obtain,

$$\begin{matrix}{x}_{k} = \frac{1}{s} [ \begin{matrix}{K}^{- 1} {K}_{0} - {I}_{N} & s {K}^{- 1} \\ s {K}^{- 1} {K}_{0} & {s}^{2} {K}^{- 1}\end{matrix} ] [ \begin{matrix}{0}_{N \times 1} \\ {b}_{k}\end{matrix} ] \\ = [ \begin{matrix}{K}^{- 1} {b}_{k} \\ s {K}^{- 1} {b}_{k}\end{matrix} ] ,\end{matrix} \\ where \qquad ( 24 )$$

$$K = {K}_{0} + s {K}_{1} + {s}^{2} {K}_{2} . \qquad ( 25 )$$

because K₀, K₁, and K₂ are symmetrical matrices, substituting (6) into (21) and using the 2×2 block matrix inversion method to obtain,

$$\begin{matrix}{\hat{x}}_{k , j} = \frac{1}{s} [ \begin{matrix}{K}^{- 1} {K}_{0} - {I}_{N} & s {K}^{- 1} {K}_{0} \\ s {K}^{- 1} & {s}^{2} {K}^{- 1}\end{matrix} ] [ \begin{matrix}s {κ}_{k , j} {b}_{k} \\ {0}_{N \times 1}\end{matrix} ] \\ = {κ}_{k , j} [ \begin{matrix}{K}^{- 1} {K}_{0} {b}_{k} - {b}_{k} \\ s {K}^{- 1} {b}_{k}\end{matrix} ] .\end{matrix} \qquad ( 26 )$$

defining ξₖ as the vector of weighted differences between \hat{x}_{k,j} and xₖ, formulated as,

$${ξ}_{k} = \frac{{\hat{x}}_{k , j}}{{κ}_{k , j}} - {x}_{k} = [ \begin{matrix}{K}^{- 1} ( {K}_{0} {b}_{k} - {b}_{k} ) - {b}_{k} \\ {0}_{N \times 1}\end{matrix} ] . \qquad ( 27 )$$

formulating \hat{x}_{k,j} by the weighted summation of xₖ and ξₖ as,

\hat{x}_{k,j}=κ_{k,j}xₖ+κ_{k,j}ξₖ, (28)

substituting (17) into (22) to obtain,

$$\begin{matrix}\frac{\partial {S}_{k , j}}{\partial {ϕ}_{i}} = - {κ}_{k , j} ( {x}_{k}^{T} + {ξ}_{k}^{T} ) ( {\tilde{G}}_{i} + s {\tilde{C}}_{i} ) {x}_{j} \\ = - {κ}_{k , j} [ {x}_{k}^{T} ( {\tilde{G}}_{i} + s {\tilde{C}}_{i} ) + {ξ}_{k}^{T} ( {\tilde{G}}_{i} + s {\tilde{C}}_{i} ) ] {x}_{j} .\end{matrix} \qquad ( 29 )$$

because

$$\begin{matrix}{( {\tilde{G}}_{i} + s {\tilde{C}}_{i} )}^{T} {ξ}_{k} = [ \begin{matrix}{0}_{N} & {\tilde{K}}_{0}^{i} \\ {0}_{N} & {\tilde{K}}_{1}^{i} + s {\tilde{K}}_{2}^{i}\end{matrix} ] [ \begin{matrix}{K}^{- 1} ( {K}_{0} {b}_{k} - {b}_{k} ) - {b}_{k} \\ {0}_{N \times 1}\end{matrix} ] \\ = {0}_{2 N \times 1} ,\end{matrix} \qquad ( 30 )$$

simplifying the formulation for calculating the derivative (29) as,

$$\frac{\partial {S}_{k , j}}{\partial {ϕ}_{i}} = - {κ}_{k , j} {x}_{k}^{T} ( {\tilde{G}}_{i} + s {\tilde{C}}_{i} ) {x}_{j} . \qquad ( 31 )$$

$$\frac{\partial {S}_{k , j}}{\partial {ϕ}_{i}} \approx - {κ}_{k , j} {x}_{k}^{q T} ( {\tilde{G}}_{i} + s {\tilde{C}}_{i} ) {x}_{j}^{q} . \qquad ( 32 )$$

Equation (20) is the self-adjoint sensitivity formula which is well fit for fast frequency sweep; MORe techniques can be used to calculate xⱼ; since the format of (31) is derived using MPVL, xⱼ can be formulated using MPVL method.

By using Equations (12)-(14), the disclosure performs the LU factorization and forward/backward substitutions of the original system Kₛ (single-size system matrix) instead of Aₛ (double-size system matrix), to reduce calculation time rₘ, m=0, 1, . . . , q. Because the MPVL method takes a long time to calculate rₘ, it is simplified for efficient xₖ calculation. Note that, according to Equations (12)-(14), the disclosure uses only one LU factorization of the original system Kₛ, whereas the MPVL method uses q+1 forward/backward substitutions.

Because Equation (31) is derived using MPVL, xⱼ and \hat{x}_{k,j} can also be formulated using the MPVL method,

$$\frac{\partial {S}_{k , j}}{\partial {ϕ}_{i}} \approx - {κ}_{k , j} {x}_{k}^{q T} ( {\tilde{G}}_{i} + s {\tilde{C}}_{i} ) {x}_{j}^{q} , \qquad ( 32 )$$

where xⱼ^{q} is calculated using fast frequency sweep with MORe technique as in equation (15). Note that, in the single-size MPVL method, {wₘ}ₘ₌₁^{q} makes each λₘ equal to non-zero. When performing MPVL method, Equation (32) calculates the derivatives of S-parameters for the self-adjoint EM sensitivity analysis. Fast frequency sweep uses a reduced-order model of order q to estimate the S-parameters of a p port structure and the derivatives thereof, and involves only one LU factorization and p (q+1) forward/backward substitutions. The computational time of the self-adjoint EM sensitivity analysis is not related to the number of physical parameters and increases slightly with the number of frequencies to be solved.

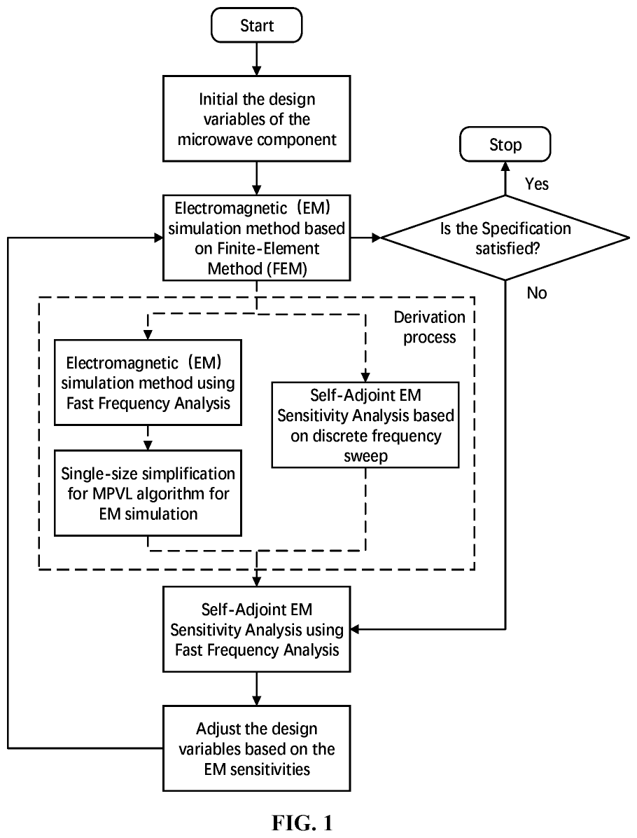

The comparison of the different methods of EM sensitivity analysis of a four-pole waveguide filter is shown in Table 1. A flow chart for the operations performed by the invented device design system in the embodiment of this microwave filter is shown in FIG. 1. The detailed number of LU factorizations and FB substitutions of the original FEM matrix for the proposed adjoint EM sensitivity analysis using fast frequency sweep is illustrated in Table 1. The disclosure further provides details of the self-adjoint EM sensitivity analysis using discrete frequency sweep, the sensitivity analysis using the finite difference method (i.e., perturbing variables, re-simulating EM and computing the solution difference) for both fast frequency sweep and discrete frequency sweep. For illustration purpose, the disclosure further provides the details of EM simulation using both fast frequency sweep and discrete frequency sweep. In Table 1, n represents the number of physical parameters; n_{f} represents the number of frequencies; q represents the order for MPVL method; p represents the number of ports of the microwave filter. From Table 1, if the EM application only simulates at 1 or 2 frequencies, the sensitivity analysis using self-adjoint EM sensitivity analysis with discrete frequency sweep is performed. If the EM application only has 1 or 2 physical parameters, the sensitivity analysis using finite difference method with fast frequency sweep is performed. If the EM application has more physical parameters and needs to simulate at more frequencies, the adjoint EM sensitivity analysis using fast frequency sweep obtains the results faster than the existing sensitivity analysis methods. The larger number of physical parameters and frequencies the EM application has, the more significant advantage the proposed method will have.

TABLE 1
Comparison of the Number of LU Factorizations and F/B
Substitutions of FEM Matrix for Different Methods

| | No. of LU | No. of F/B |
|---|---|---|
| Method | Factorizations | Substitutions |
| Proposed Self-Adjoint | 1 | p(q + 1) |
| EM Sensitivity Analysis | | |
| Using Fast Frequency | | |
| Sweep | | |
| Proposed Adjoint EM | 1 | p(2q + 2) |
| Sensitivity Analysis | | |
| Using Fast Frequency | | |
| Sweep | | |
| Self-Adjoint EM | n_{f} | p · n_{f} |
| Sensitivity Analysis | | |
| Using Discrete Frequency | | |
| Sweep | | |
| Finite-Difference | n + 1 | p(q + l)(n + 1) |
| Sensitivity Using Fast | | |
| Frequency Sweep | | |
| Finite-Difference | n_{f}(n + 1) | p · n_{f}(n + 1) |
| Sensitivity Analysis | | |
| Using Discrete Frequency | | |
| Sweep | | |
| Fast Frequency Sweep | 1 | p(q + 1) |
| Simulation | | |
| Discrete Frequency | n_{f} | p • n_{f} |
| Sweep Simulation | | |

n—Number of Physical Parameters;

n_{f}- Number of Frequencies at a Frequency range;

q—Order for MPVL method;

p—Number of ports of the microwave filter.

Remarks: Note that, the self-adjoint EM sensitivity method takes the same number of LU decomposition and F/B substitutions as EM simulation using fast frequency sweep using finite element method. In another word, after performing EM simulation using fast frequency sweep, no extra LU or F/B time is needed to calculate the EM sensitivities wr.t. all variables. Only a small amount of extra time of matrix multiplications is needed for EM sensitivity analysis after EM simulation.

4. Sensitivity Analysis for Four-Pole Waveguide Filter

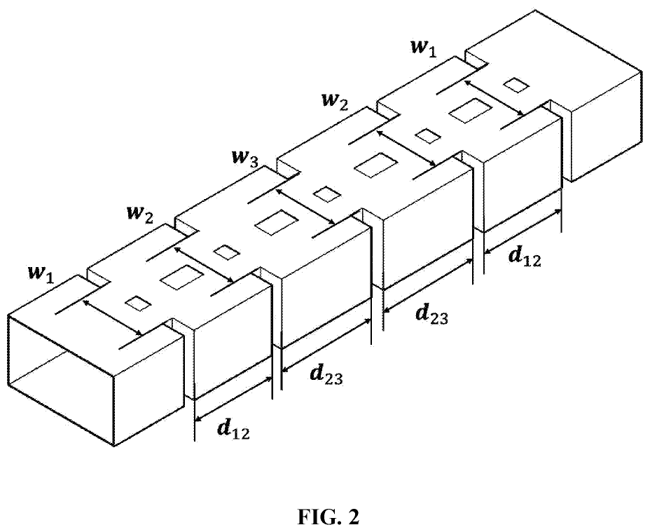

The example under consideration is the EM sensitivity analysis of a four-pole waveguide filter. The tuning elements are penetrating posts of square cross section placed at the center of each cavity and each coupling window, shown in FIG. 2. Let h₁, h₂, h₃ represent the heights of the tuning posts in the coupling windows. Let h_{c1} and h_{c2} represent the heights of the square cross section placed in the center of the resonator cavities. Let w_{c} and wₚ represent the widths of the square cross section placed at the center of the resonant cavity and the coupling window respectively. Let d₁₂ and d₂₃ represent the diameters of resonant cavities. The iris widths w₁, w₂, w₃ and w₄ are pre-tuned to achieve the desired coupling bandwidth for each section of the filter. The input and output waveguides, as well as the resonant cavities, are standard WR-75 waveguides (a=19.05 mm and b=9.525 mm). For this example, the design space vector is ϕ=[d₁₂ d₂₃ h₁ h₂ h₃ h_{c1} h_{c2} w₁ w₂ w₃ Wₚ W_{c}]^{T} The sensitivity analysis is performed at the nominal design point, i.e., (Pᵢ=[10.5 13.3 3.39 4.15 3.62 3.30 2.98 8.7 5.1 5.1 2.0 4.0]^{T} mm. The frequency range for this filter is selected as 10.5 GHz-11.5 GHz with the step of 20 MHz.

The derivatives of S-parameters for the microwave filter device is calculated by the proposed self-adjoint EM sensitivity analysis using fast frequency sweep for the EM simulation of this filter example. The order for the reduced order model is 16, i.e., q=16. Through the instant EM device design system disclosed in this embodiment for the microwave filter, physical specifications, such as passband bandwidth, return loss, and passband ripple can be satisfied.

For comparison purposes, the disclosure further provides the self-adjoint EM sensitivity analysis using discrete frequency analysis, the sensitivity analysis using the finite difference method for fast frequency sweep and discrete frequency analysis. Three cases for the sensitivity analysis with different number of frequency points are performed for the comparison: Case 1 with 11 frequency points and Case 2 with 51 frequency points. The comparison of the different methods of sensitivity analysis for the four-pole waveguide filter example is shown in Table 2.

TABLE 2
Comparison of CPU of different sensitivity analysis methods for the four-
pole waveguide filter

| | | No. of LU | No. of F/B | Time of LU | Total |
|---|---|---|---|---|---|
| | Sensitivity method | factorizations | substitutions | Factorizations | Time |
| 11 Frequencies | Proposed Self- | 1 | 34 | 2.1 min | 4.1 |
| | adjoint EM | | | | min |
| | sensitivity analysis | | | | |
| | Using Fast | | | | |
| | frequency sweep | | | | |
| | Proposed Adjoint | 1 | 68 | 2.1 min | 6.2 |
| | EM Sensitivity | | | | min |
| | Analysis Using Fast | | | | |
| | frequency sweep | | | | |
| | Self-adjoint EM | 11 | 22 | 22.3 min | 23.9 |
| | sensitivity analysis | | | | min |
| | Using Discrete | | | | |
| | Frequency Analysis | | | | |
| | Finite-Difference | 13 | 442 | 26.4 min | 41.2 |
| | Sensitivity Analysis | | | | min |
| | Using Fast | | | | |
| | frequency sweep | | | | |
| | Finite-Difference | 143 | 286 | 4.7 h | 4.9 h |
| | Sensitivity Analysis | | | | |
| | Using Discrete | | | | |
| | Frequency Sweep | | | | |
| 101 Frequencies | Proposed Self- | 1 | 34 | 2.1 min | 4.1 |
| | adjoint EM | | | | min |
| | sensitivity analysis | | | | |
| | Using Fast | | | | |
| | Frequency Sweep | | | | |
| | Proposed Adjoint | 1 | 68 | 2.1 min | 6.2 |
| | Sensitivity Analysis | | | | min |
| | Using Fast | | | | |
| | frequency sweep | | | | |
| | Self-adjoint EM | 102 | 204 | 3.3 h | 3.4 h |
| | sensitivity analysis | | | | |
| | Using Discrete | | | | |
| | Frequency Sweep | | | | |
| | Finite-Difference | 13 | 442 | 26.4 min | 41.2 |
| | Sensitivity Analysis | | | | min |
| | Using Fast | | | | |
| | Frequency Sweep | | | | |
| | Finite-Difference | 1326 | 2652 | 44.3 h | 45.1 |
| | Sensitivity Analysis | | | | h |
| | Using Discrete | | | | |
| | Frequency Sweep | | | | |

Because 12 physical parameters are used in this example, 13 complete evaluations of the S-parameters (once at nominal values and 12 perturbations for 12 different physical parameters) are needed for the sensitivity analysis using the finite different method. For the self-adjoint EM sensitivity analysis using discrete frequency analysis, the cost increases as the number of frequency points for the EM design increases. From Table 2, the self-adjoint EM sensitivity analysis uses only one LU factorization and 34 forward/backward substitutions to obtain the derivatives of the S-parameters w.r.t 12 different physical parameters. The LU factorizations and forward/backward substitutions are the most time-consuming part during the overall sensitivity analysis process. The number of LU factorizations and forward/backward substitutions used by the proposed method is much fewer than that used by the existing methods listed in Table 2, therefore, the disclosed method takes much less time than the existing methods.

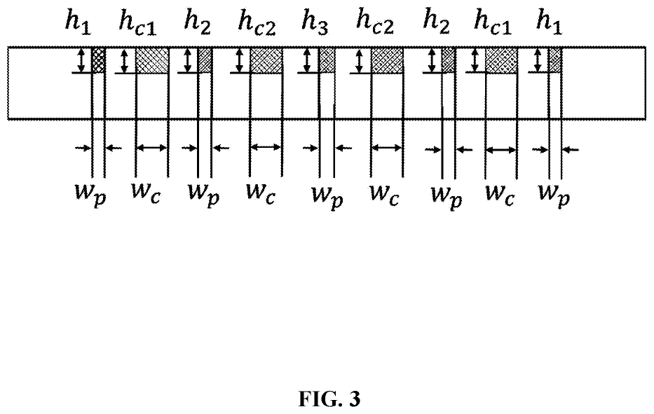

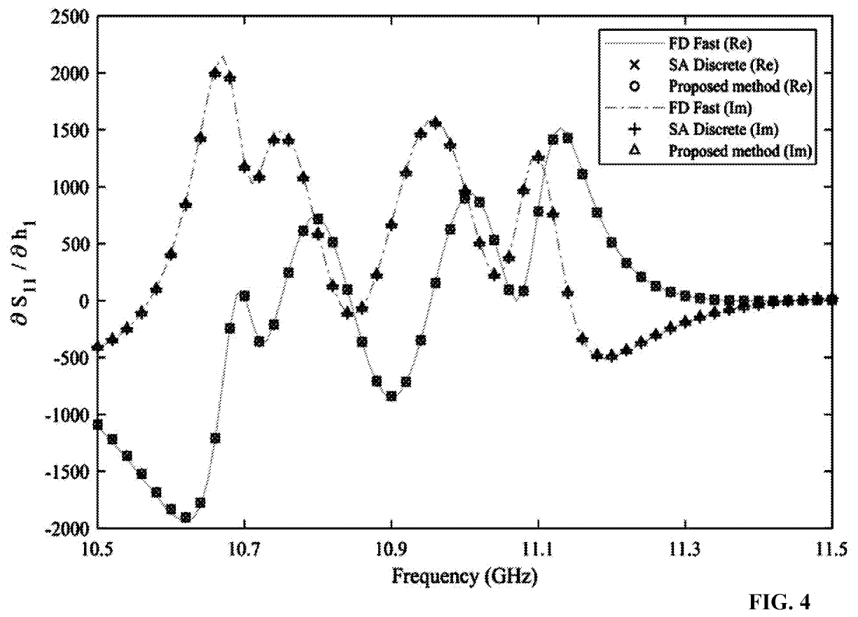

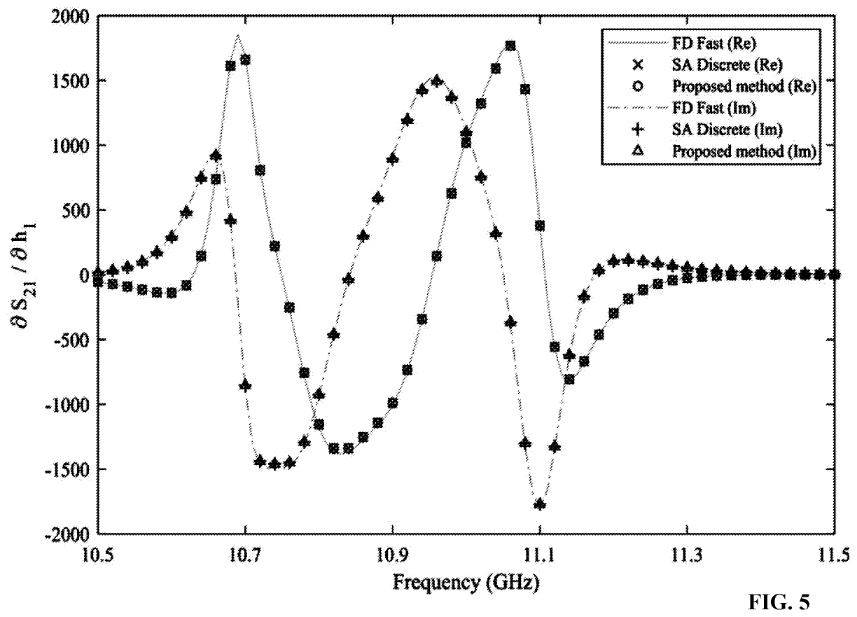

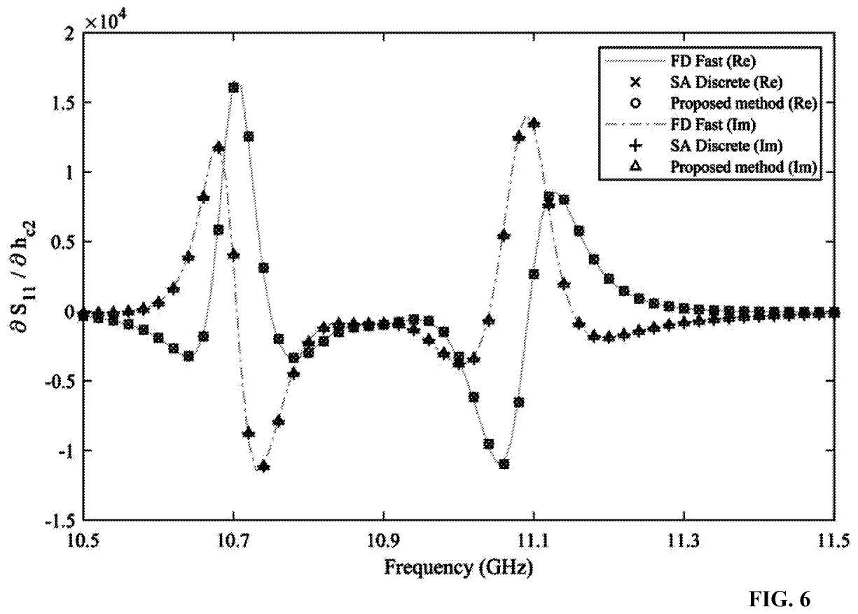

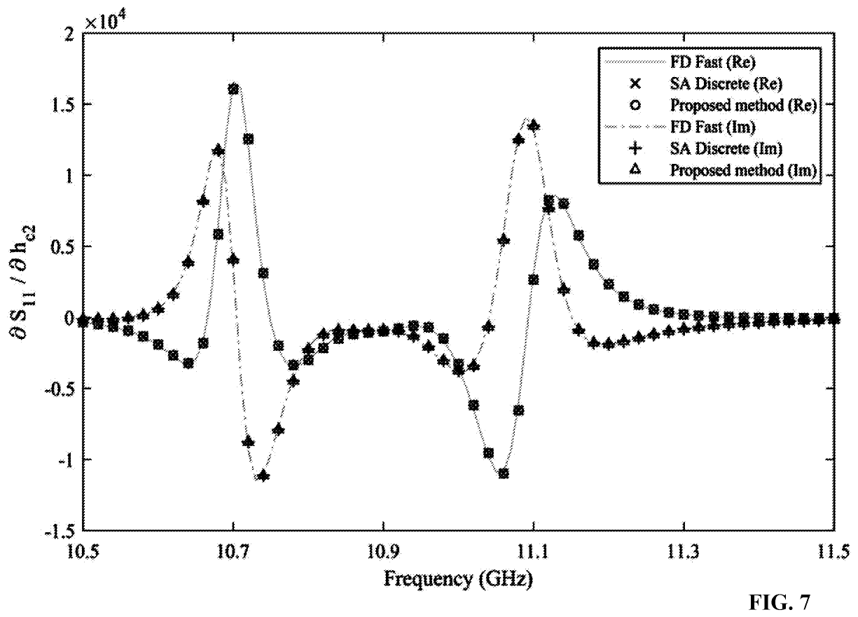

FIG. 4 and FIG. 5 show detailed comparisons of the derivatives of S₁₁ and S₂₁ with respect to h₁ for the four-pole waveguide filter with the frequency swept from 10.5 GHz-11.5 GHz, respectively. As shown in FIG. 3 and FIG. 4, the derivatives calculated using the self-adjoint EM sensitivity analysis match very well with the derivatives calculated using the existing self-adjoint method and finite difference methods. To further verify the accuracy of the proposed self-adjoint EM sensitivity analysis method, the disclosure further provides the calculation of the derivatives of S-parameters w.r.t. other physical parameters. Detailed comparisons of the derivatives of S₁₁ and S₂₁ with respect to h_{c2} for this four-pole waveguide filter are shown in FIG. 6 and FIG. 7, respectively. From the comparisons, the self-adjoint EM sensitivity analysis using fast frequency sweep achieves the correct solution with a very low computational cost.

Appendix 1: Single-Size MPVL Method for EM sensitivity Analysis

1) Define δ_{k,j}, κ_{k,j}, e₁, I_{q}, K₀, K₁, K₂, bₖ, bⱼ. Define frequency s. Define pre-solution frequency s₀.

Define {wₘ}ₘ₌₁^{q}. Set Kₛ=K₀+s₀K₁+s₀²K₂

2) Obtain u₀ by solving the linear system Kₛu₀=b₁. Set

$${r}_{0} = [ \begin{matrix}{u}_{0} \\ {s}_{0} {u}_{0}\end{matrix} ] and r = {r}_{0} .$$

For m=1, 2, q do:

3) Set

$${v}_{m} = \frac{r}{‖ r ‖} and {λ}_{m} = {w}_{m}^{T} {v}_{m} .$$

4) If m>1, set

t_{m,m-1}=∥r∥.

5) Solving the linear system to obtain um,

$${K}_{s} {u}_{m} = {\frac{1}{{S}_{0}} [ \begin{matrix}{K}_{0} \\ - {s}_{0} {K}_{2}\end{matrix} ]}^{T} {v}_{m} .$$

Calculate

$$r = {r}_{m} = [ \begin{matrix}{u}_{m} \\ {s}_{0} {u}_{m}\end{matrix} ] - \frac{1}{{S}_{0}} [ \begin{matrix}{I}_{N} & {0}_{N} \\ {0}_{N} & {0}_{N}\end{matrix} ] {v}_{m} .$$

6) For l=1, 2, . . . , m do: Set

$${t}_{l , m} = \frac{{w}_{l}^{T} r}{{λ}_{l}} and r = r - {t}_{l , m} {v}_{l} .$$

End For

End For

7) Set

Tⱼ^{q}=[t_{l,m}]_{q×q},Vⱼ^{q}=[v₁v₂ . . . v_{q}].

xⱼ≈∥r₀∥Vⱼ^{q}(I_{q}−(s−s₀)Tⱼ^{q})⁻¹e₁.

8) Calculate

$${S}_{k , j} ( s ) \approx s ‖ {r}_{0} ‖ {{κ}_{k , j} [ \begin{matrix}{b}_{k} \\ {0}_{N \times 1}\end{matrix} ]}^{T} {{V}_{j}^{q} ( {I}_{q} - ( s - {s}_{0} ) {T}_{j}^{q} )}^{- 1} {e}_{1} - {δ}_{k , j} .$$

Appendix 2: Adjoint Electromagnetic Sensitivity Analysis using Single-Size MPVL Method

1) Define κ_{k,j}, e₁, I_{q}, \tilde{G}ᵢ, \tilde{C}ᵢ, K₀, K₁, K₂, \hat{β}_{k,j}, and bⱼ.

Define frequency s. Define pre-solution frequency s₀.

Define {wₘ}ₘ₌₁^{q}. Set Kₛ=K₀+s₀K₁+s₀²K₂.

2) Obtain u₀ by solving the linear system Kₛu₀=b₁.

Set

$${r}_{0} = [ \begin{matrix}{u}_{0} \\ {s}_{0} {u}_{0}\end{matrix} ] and r = {r}_{0} .$$

For m=1, 2, . . . , q do:

3) Set

$${v}_{m} = \frac{r}{‖ r ‖} and {λ}_{m} = {w}_{m}^{T} {v}_{m} .$$

4) If m>1, set

t_{m,m-1}=∥r∥.

5) Solving the linear system to obtain um,

$${K}_{s} {u}_{m} = {\frac{1}{{s}_{0}} [ \begin{matrix}{K}_{0} \\ - {s}_{0} {K}_{2}\end{matrix} ]}^{T} {v}_{m} .$$

Calculate

$$r = {r}_{m} = [ \begin{matrix}{u}_{m} \\ {s}_{0} {u}_{m}\end{matrix} ] - \frac{1}{{s}_{0}} [ \begin{matrix}{I}_{N} & {0}_{N} \\ {0}_{N} & {0}_{N}\end{matrix} ] {v}_{m .}$$

6) For l=1, 2, . . . , m do: Set

$${t}_{l , m} = \frac{{w}_{l}^{T} r}{{λ}_{l}} and r = r - {t}_{l , m} {v}_{l} .$$

End For

End For

7) Set

Tₖ^{q}=[t_{l,m}]_{q-q},Vₖ^{q}=[v₁v₂ . . . v_{q}],

xⱼ^{q}=∥r₀∥Vⱼ^{q}(I_{q}−(s−s₀)Tⱼ^{q})⁻¹e₁.

8) Repeat 2)-7) by changing bⱼ to \hat{β}_{k,j} to calculate \hat{x}_{k,j}^{qT}

9) Calculate

$$\frac{\partial {S}_{k , j}}{\partial {ϕ}_{i}} \approx - {\hat{x}}_{k , j}^{{q}^{T}} ( {\tilde{G}}_{i} + s {\tilde{C}}_{i} ) {x}_{j}^{q} .$$

Appendix 3: Self-Adjoint Electromagnetic Sensitivity Analysis using Single-Size MPVL Method

1) Define κ_{k,j}, e₁, I_{q}, \tilde{G}ᵢ, \tilde{C}ᵢ, K₀, K₁, K₂, bₖ, and bⱼ.

Define frequency s. Define pre-solution frequency s₀.

Define {wₘ}ₘ₌₁^{q}. Set Kₛ=K₀+s₀K₁+s₀²K₂.

2) Obtain u₀ by solving the linear system Kₛu₀=bⱼ.

Set

$${r}_{0} = [ \begin{matrix}{u}_{0} \\ {s}_{0} {u}_{0}\end{matrix} ] and r = {r}_{0} .$$

For m=1, 2, . . . , q do:

3) Set

$${v}_{m} = \frac{r}{‖ r ‖} and {λ}_{m} = {w}_{m}^{T} {v}_{m} .$$

4) If m>1, set

t_{m,m-1}=∥r∥.

5) Solving the linear system to obtain um,

$${K}_{s} {u}_{m} = {\frac{1}{{s}_{0}} [ \begin{matrix}{K}_{0} \\ - {s}_{0} {K}_{2}\end{matrix} ]}^{T} {v}_{m} .$$

Calculate

$$r = {r}_{m} = [ \begin{matrix}{u}_{m} \\ {s}_{0} {u}_{m}\end{matrix} ] - \frac{1}{{s}_{0}} [ \begin{matrix}{I}_{N} & {0}_{N} \\ {0}_{N} & {0}_{N}\end{matrix} ] {v}_{m} .$$

6) For l=1, 2, . . . , m do: Set

$${t}_{l , m} = \frac{{w}_{l}^{T} r}{{λ}_{l}} and r = r - {t}_{l , m} {v}_{l} .$$

End For

End For

7) Set

Tⱼ^{q}=[t_{l,m}]_{q×q},Vⱼ^{q}=[v₁v₂ . . . v_{q}],

xⱼ^{q}=∥r₀∥Vⱼ^{q}(I_{q}−(s−s₀)Tⱼ^{q})⁻¹e₁.

8) Repeat 2)-7) by changing bⱼ to bₖ to calculate xₖ^{q}.

9) Calculate

$$\frac{\partial {S}_{k , j}}{\partial {ϕ}_{i}} \approx - {κ}_{k , j} {x}_{k}^{{q}^{T}} ( {\tilde{G}}_{i} + s {\tilde{C}}_{i} ) {x}_{j}^{q} .$$

What is claimed is:

1. An electromagnetic device design system comprising:
one or more processors of a machine; and
computer-storage medium storing instructions, which when executed by the machine, cause the machine to perform operations for EM sensitivity analysis for an electromagnetic (EM) device, the operations comprising:
initiating physical parameters of the EM device, wherein the EM device comprises multiple ports;
performing EM simulation for the EM device at a pre-solution frequency using the finite-element method (FEM);
applying single-size matrix Padé via Lanczos (MPVL) method in fast frequency sweep and performing EM simulation for the EM device under excitation at each port to obtain field solutions of the EM device in a frequency range;
calculating S-parameters for the multiple ports of the EM device;
obtaining derivatives of a full scattering matrix for the multiple ports with respect to the physical parameters of the EM device in the frequency range;
selecting a solution and updating EM device design to replace initial values of the physical parameters of the EM device with a selected solution;
performing EM simulation for the EM device at a frequency of the selected solution using FEM; and
determining the simulated result satisfies a physical specification of the EM device;
wherein:
applying single-size MPVL method in fast frequency sweep comprises:
transforming a single-size system matrix with a dimension of N×N into a double-size system matrix with a dimension of 2N×2N for omitting second order terms of frequency, wherein N represents a number of elements in a field vector and the single-size system matrix is of a linear combination of global finite-element system matrices;
generating a first linear system using the double-size system matrix;
representing solving vectors of the first linear system with the global finite-element system matrices using the block matrix inversion method and transforming the first linear system into a second linear system, wherein the second linear system is of the single-size system matrix; and
solving the second linear system by performing fast frequency sweep incorporated with MPVL method and obtaining field solution in a frequency range as the following:
xₖ≈xₖ^{q}=∥r₀∥vₖ^{q}(I_{q}−(s−s₀)Tₖ^{q})⁻¹e₁
where
s represents a frequency;
s₀ represents a pre-solution frequency;
q is a reduced order in MPVL method;
xₖ is a vector of field solution under excitation at port k;
xₖ^{q} represents a vector of qₜₕ order reduced field solution under excitation at port k;
r₀ represents a solution vector of the first linear system at 0^{th} MPVL iteration;
Vₖ^{q} is represented as Vₖ^{q}=[vₘ]ₘ₌₁^{q}=[v₁ v₂ . . . v_{q}], where vₘ is an orthonormal basis vector of the Krylov subspace for model order reduction;
I_{q} is an identity matrix with a dimension of q×q;
Tₖ^{q}, is a reduced order matrix; and
e₁ is represented as e₁=[1 0 . . . 0]^{T} with a dimension of 1×q.

2. An electromagnetic device design system comprising:
one or more processors of a machine; and
computer-storage medium storing instructions, which when executed by the machine, cause the machine to perform operations for EM sensitivity analysis for an electromagnetic (EM) device, the operations comprising:
initiating physical parameters of the EM device wherein the EM device comprises multiple ports;
performing EM simulation for the EM device at a pre-solution frequency using the finite-element method (FEM);
solving a linear system under excitation at port j to obtain a field solution under excitation at port j by fast frequency sweep;
solving an adjoint representation of the linear system under excitation at port k to obtain an adjoint field solution between port k and port j by fast frequency sweep;
calculating derivatives of a S-parameter of port j and port k with respect to ϕᵢ based on an adjoint sensitivity formula;
obtaining derivatives of a full scattering matrix for the multiple ports with respect to the physical parameters of the EM device in the frequency range;
selecting a solution and updating EM device design to replace the one of the physical parameters of the EM device with the selected solution;
performing EM simulation for the EM device at a frequency of the selected solution using FEM; and
determining the simulated result satisfies a physical specification of the EM device;
wherein the adjoint sensitivity formula is written as
$$\frac{\partial {S}_{k , j}}{\partial {ϕ}_{i}} = - {\hat{x}}_{k , j}^{T} ( {\tilde{G}}_{i} + s {\tilde{C}}_{i} ) {x}_{j} ,$$
where
xⱼ represents a vector of the field solution under excitation at port j;
\tilde{G}ᵢ represents a derivative of G with respect to ϕᵢ;
\tilde{C}ᵢ represents a derivative of C with respect to ϕᵢ;
s is a frequency;
\hat{x}_{k,j}^{T} represents a transpose vector of the adjoint field solution between port j and port k;
S_{k,j} represents the S-parameter of port j and port k; and
ϕᵢ represents an iₜₕ one of the physical parameters.

3. An electromagnetic device design system comprising:
one or more processors of a machine; and
computer-storage medium storing instructions, which when executed by the machine, cause the machine to perform operations for EM sensitivity analysis for an electromagnetic (EM) device, the operations comprising:
initiating physical parameters of the EM device wherein the EM device comprises multiple ports;
performing EM simulation for the EM device at a pre-solution frequency using the finite-element method (FEM);
solving a linear system under excitation at port j to obtain a field solution under excitation at port j by fast frequency sweep;
solving the linear system under excitation at port k to obtain a field solution under excitation at port k by fast frequency sweep;
calculating derivatives of a S-parameter of port j and port k with respect to ϕᵢ based on a self-adjoint sensitivity formula;
obtaining derivatives of a full scattering matrix for the multiple ports with respect to the physical parameters of the EM device in the frequency range;
selecting a solution and updating EM device design to replace initial values of the physical parameters of the EM device with the selected solution;
performing EM simulation for the EM device at a frequency of the selected solution using FEM; and
determining the simulated result satisfies a physical specification of the EM device;
wherein
the self-adjoint sensitivity formula is written as
$$\frac{\partial {S}_{k , j}}{\partial {ϕ}_{i}} = - {κ}_{k , j} {x}_{k}^{T} ( {\tilde{G}}_{i} + s {\tilde{C}}_{i} ) {x}_{j} ,$$
where
xⱼ represents a vector of the field solution under excitation at port j;
\tilde{G}ᵢ represents a derivative of G with respect to ϕᵢ;
\tilde{C}ᵢ represents a derivative of C with respect to ϕᵢ;
s is a frequency;
xₖ^{T} represents a transpose vector of the field solution under excitation at port k;
S_{k,j} represents the S-parameter of port j and port k;
ϕᵢ represents an iₜₕ one of the physical parameters; and
K_{k,j} represents a correlated coefficient of port j and port k.

4. An electromagnetic device design system comprising:
one or more processors of a machine; and
computer-storage medium storing instructions, which when executed by the machine, cause the machine to perform operations for EM sensitivity analysis for an electromagnetic (EM) device, the operations comprising:
initiating physical parameters of the EM device wherein the EM device comprises multiple ports;
performing EM simulation for the EM device at a pre-solution frequency using the finite-element method (FEM);
solving a linear system under excitation at port j by performing fast frequency sweep with single-size MPVL method to obtain an order reduced field solution under excitation at port j in a frequency range;
solving an adjoint representation of the linear system under excitation at port k by performing fast frequency sweep with single-size MPVL method to obtain an order reduced adjoint field solution between port k and port j in the frequency range;
calculating derivatives of a S-parameter of port j and port k with respect to ϕᵢ based on an adjoint sensitivity formula;
obtaining derivatives of a full scattering matrix for the multiple ports with respect to the physical parameters of the EM device in the frequency range;
selecting a solution and updating EM device design to replace initial values of the physical parameters of the EM device with the selected solution;
performing EM simulation for the EM device at a frequency of the selected solution using FEM; and
determining the simulated result satisfies a physical specification of the EM device;
wherein:
performing fast frequency sweep with single-size MPVL method comprises:
transforming a single-size system matrix with a dimension of N×N into a double-size system matrix with a dimension of 2N×2N for omitting second order terms of frequency, wherein N represents the number of elements in a field vector and the single-size system matrix comprises a linear combination of global finite-element system matrices;
generating a first linear system using the double-size system matrix;
representing solving vectors of the first linear system with the global finite-element system matrices using block matrix inversion method and transforming the first linear system into a second linear system, wherein the second linear system is of the single-size system matrix; and
solving the second linear system by performing fast frequency sweep incorporated with MPVL method and obtaining a field solution in a frequency range by the following:
xₖ≈xₖ^{q}=∥r₀∥vₖ^{q}(I_{q}−(s−s₀)Tₖ^{q})⁻¹e₁;
and the adjoint sensitivity formula is written as:
$$\frac{\partial {S}_{k , j}}{\partial {ϕ}_{i}} \approx - {\hat{x}}_{k , j}^{Tq} ( {\tilde{G}}_{i} + s {\tilde{C}}_{i} ) {x}_{j}^{q} ,$$
where
s represents a frequency;
s₀ represents a pre-solution frequency;
q is a reduced order in MPVL method;
xₖ is a vector of field solution under excitation at port k;
xₖ^{q} represents a vector of qₜₕ order reduced field solution under excitation at port k;
r₀ represents a solution vector of the first linear system at 0^{th} MPVL iteration;
Vₖ^{q} is represented as Vₖ^{q}=[vₘ]ₘ₌₁^{q}=[v₁ v₂ . . . v_{q}], where vₘ is an orthonormal basis vector of the Krylov subspace for model order reduction;
I_{q} is an identity matrix with a dimension of q×q;
Tₖ^{q} is a reduced order matrix;
e₁ is represented as e₁=[1 0 . . . 0]^{T} with a dimension of 1×q;
\tilde{G}ᵢ represents a derivative of G with respect to ϕᵢ;
\tilde{C}ᵢ represents a derivative of C with respect to ϕᵢ;
\hat{x}_{k,j}^{qT} represents a transpose vector of qth order reduced adjoint field solution between port j and port k;
S_{k,j} represents the S-parameter of port j and port k; and
ϕᵢ represents an iₜₕ one of the physical parameters.

5. An electromagnetic device design system comprising:
one or more processors of a machine; and
computer-storage medium storing instructions, which when executed by the machine, cause the machine to perform operations for EM sensitivity analysis for an electromagnetic (EM) device, the operations comprising:
initiating physical parameters of the EM device wherein the EM device comprises multiple ports;
performing EM simulation for the EM device at a pre-solution frequency using the finite-element method (FEM);
performing fast frequency sweep with single-size MPVL method to obtain an order reduced field solution under excitation at port j of the EM device in a frequency range;
performing fast frequency sweep with single-size MPVL method to obtain an order reduced field solution under excitation at port k of the EM device in a frequency range;
calculating derivatives of a S-parameter of port j and port k with respect to ϕᵢ based on a self-adjoint sensitivity formula;
obtaining derivatives of a full scattering matrix for the multiple ports with respect to the physical parameters of the EM device in the frequency range;
selecting a solution and updating EM device design to replace initial values of the physical parameters of the EM device with the selected solution;
performing EM simulation for the EM device at a frequency of the selected solution using FEM; and
determining the simulated result satisfies a physical specification of the EM device;
wherein:
performing fast frequency sweep with single-size MPVL method comprises:
transforming a single-size system matrix with a dimension of N×N into a double-size system matrix with a dimension of 2N×2N for omitting second order terms of frequency, wherein N represents the number of elements in a field vector and the single-size system matrix comprises a linear combination of global finite-element system matrices;
generating a first linear system using the double-size system matrix;
representing solving vectors of the first linear system with the global finite-element system matrices using block matrix inversion method and transforming the first linear system into a second linear system, wherein the second linear system is of the single-size system matrix; and
solving the second linear system by performing fast frequency sweep incorporated with MPVL method and obtaining field solution of the EM device in a frequency range as the following:
xₖ≈xₖ^{q}=∥r₀∥Vₖ^{q}(I_{q}−(s−s₀)Tₖ^{q})⁻¹e₁,
and the self-adjoint sensitivity formula is written as
$$\frac{\partial {S}_{k , j}}{\partial {ϕ}_{i}} \approx - {κ}_{k , j} {x}_{k}^{qT} ( {\tilde{G}}_{i} + s {\tilde{C}}_{i} ) {x}_{j}^{q} ,$$
where
s represents a frequency;
s₀ represents a pre-solution frequency;
q is a reduced order in MPVL method;
xₖ is a vector of the field solution under excitation at port k;
xₖ^{q} represents qₜₕ order reduced solution vector under excitation at port k;
r₀ represents a solution vector of the first linear system at 0^{th} MPVL iteration;
Vₖ^{q} is represented as Vₖ^{q}=[vₘ]ₘ₌₁^{q}=[v₁ v₂ . . . v_{q}], where vₘ is an orthonormal basis vector of the Krylov subspace for model order reduction;
I_{q} is an identity matrix with a dimension of q×q;
Tₖ^{q}, is a reduced order matrix;
e₁ is represented as e₁=[1 0 . . . 0]^{T} with a dimension of 1×q;
xⱼ^{q} represents qₜₕ order reduced solution vector under excitation at port j;
\tilde{G}ᵢ represents a derivative of G with respect to ϕᵢ;
\tilde{C}ᵢ represents a derivative of C with respect to ϕᵢ;
xₖ^{qT} represents a transpose vector of qth order reduced field solution under excitation at port k;
S_{k,j} represents the S-parameter of port j and port k;
ϕᵢ represents an iₜₕ one of the physical parameters; and
κ_{k,j} represents a correlated coefficient of port j and port k.
